(19) United States
(12) Patent Application Publication
(10) Pub. No.: US 2025/0290789 A1
(43) Pub. Date: Sep. 18, 2025

(54) CLASSIFICATION DEVICE, LEARNING-MODEL GENERATION DEVICE, CLASSIFICATION METHOD, AND LEARNING-MODEL GENERATION METHOD

(71) Applicant: Panasonic Intellectual Property Management Co., Ltd., Osaka (JP)

(72) Inventors: Suguru NAKAO, Hyogo (JP); Kei TASAKA, Osaka (JP); Yuki IWAMOTO, Hiroshima (JP); Takeshi UEDA, Osaka (JP)

(21) Appl. No.: 19/222,395

(22) Filed: May 29, 2025

Related U.S. Application Data
(63) Continuation of application No. PCT/JP2023/037807, filed on Oct. 19, 2023.

(30) Foreign Application Priority Data
Nov. 30, 2022 (JP) 2022-192332

(51) Int. Cl. G01H 11/08

(52) U.S. Cl. CPC G01H 11/08

(57) ABSTRACT

A classification device includes: an acquisition unit that acquires time-axis waveform data of an object; a conversion unit that converts the time-axis waveform data into first frequency characteristic data; a spectrum calculator that divides the first frequency characteristic data into division sections by a predetermined bandwidth and calculates a maximum value of a spectrum for each of the division sections; an approximation processing unit that outputs second frequency characteristic data obtained by approximating the first frequency characteristic data on the basis of the maximum value of the spectrum for each of the division sections; a generator that generates third frequency characteristic data from the second frequency characteristic data by using a learning model; and a classification unit that classifies the object on the basis of the second frequency characteristic data and the third frequency characteristic data, in which the learning model is a model that has learned approximated learning data.

### TECHNICAL FIELD

The present disclosure relates to a classification device, a learning-model generation device, a classification method, and a learning-model generation method.

### BACKGROUND ART

PTL 1 discloses an abnormal sound inspection method for a rotary machine, the inspection method performing quality determination on the basis of a difference between an inspection target spectral distance and an average value of non-defective product spectral distances. The abnormal sound inspection method for a rotary machine detects operation sounds of a predetermined number of non-defective product rotary machines as non-defective product sample data, performs frequency analysis on each non-defective product sample data to express the operation sounds as power spectra, performs octave analysis on the power spectra to obtain respective predetermined octave band spectra, and then calculates the average value of non-defective product spectral distances obtained as a sum of squares of errors between an average spectrum obtained by averaging these spectra and an octave band spectrum based on each non-defective product sample data. The abnormal sound inspection method for a rotary machine calculates an inspection target spectral distance obtained by similar processing using an operation sound of the inspection target rotary machine as an inspection target sample, and then performs quality determination on the basis of a difference between the inspection target spectral distance and the average value of the non-defective product spectral distances.

Furthermore, PTL 2 discloses a sound inspection method for an electric shaver in which sound components generated from the electric shaver during work are divided into a frequency band occupied by sound generated from a drive source portion and a frequency band occupied by sound generated from a shaving portion, and the quality of the electric shaver is determined by comparing a sound volume value in each frequency band with a respective one of sound volume reference values of the drive source and the shaving portion set in advance for quality determination.

### CITATION LIST

### Patent Literature

PTL 1: Unexamined Japanese Patent Publication No. H10-002789
PTL 2: Unexamined Japanese Patent Publication No. S61-073031

### SUMMARY OF THE INVENTION

The present disclosure has been made in view of the above-described conventional situation, and an object thereof is to provide a classification device, a learning-model generation device, a classification method, and a learning-model generation method capable of executing non-defective product determination of an inspection object regardless of an individual difference of the inspection object.

The present disclosure provides a classification device that classifies an object having a drive source, the drive source periodically being driven, the classification device including: an acquisition unit that acquires time-axis waveform data of the object; a conversion unit that converts the time-axis waveform data into first frequency characteristic data; a spectrum calculator that divides the first frequency characteristic data into division sections by a predetermined bandwidth and calculates a maximum value of a spectrum for each of the division sections; an approximation processing unit that outputs second frequency characteristic data obtained by approximating the first frequency characteristic data on the basis of the maximum value of the spectrum for each of the division sections; a generator that generates third frequency characteristic data from the second frequency characteristic data by using a learning model; and a classification unit that classifies the object on the basis of the second frequency characteristic data and the third frequency characteristic data, in which the learning model is a model that has learned at least learning data approximated by the approximation processing unit.

Furthermore, the present disclosure provides a learning-model generation device that performs learning on an object having a drive source, the drive source periodically being driven, the learning-model generation device including: an acquisition unit that acquires time-axis waveform data of the object; a conversion unit that converts the time-axis waveform data into first frequency characteristic data; a spectrum calculator that divides the first frequency characteristic data into division sections by a predetermined bandwidth and calculates a maximum value of a spectrum for each of the division sections; an approximation processing unit that outputs second frequency characteristic data obtained by approximating the first frequency characteristic data on the basis of the maximum value of the spectrum for each of the division sections; and a learning model generator that causes a learning model to learn a plurality of the second frequency characteristic data.

Furthermore, the present disclosure provides a classification method performed by a classification device that classifies an object having a drive source, the drive source periodically being driven, the classification method including: acquiring time-axis waveform data of the object; converting the time-axis waveform data into first frequency characteristic data; dividing the first frequency characteristic data into division sections by a predetermined bandwidth and calculates a maximum value of a spectrum for each of the division sections; outputting second frequency characteristic data obtained by approximating the first frequency characteristic data on the basis of the maximum value of the spectrum for each of the division sections; generating third frequency characteristic data from the second frequency characteristic data by using a learning model; and classifying the object on the basis of the second frequency characteristic data and the third frequency characteristic data, in which the learning model is a model that has learned at least learning data approximated by the classification device.

Furthermore, the present disclosure provides a learning-model generation method performed by a learning-model generation device that performs learning on an object having a drive source, the drive source periodically being driven, the learning-model generation method including: acquiring time-axis waveform data of the object; converting the time-axis waveform data into first frequency characteristic data; dividing the first frequency characteristic data into division sections by a predetermined bandwidth and calculating a maximum value of a spectrum for each of the division sections; outputting second frequency characteristic data obtained by approximating the first frequency characteristic data on the basis of the maximum value of the spectrum for each of the division sections; and causing a learning model to learn a plurality of the second frequency characteristic data.

According to the present disclosure, the non-defective product determination of the inspection object can be executed regardless of the individual difference of the inspection object.

### BRIEF DESCRIPTION OF THE DRAWINGS

FIG. 1 is a diagram illustrating an example of an inspection object and an inspection jig according to a first exemplary embodiment.

FIG. 2 is a diagram illustrating an example of an inspection object and an inspection jig according to the first exemplary embodiment.

FIG. 3 is a cross-sectional view of the inspection jig taken along line X-Z.

FIG. 4 is a block diagram illustrating an example of an internal configuration of a non-defective product determination device according to the first exemplary embodiment.

FIG. 5 is a flowchart illustrating an example of an overall operation procedure of a terminal device according to the first exemplary embodiment.

FIG. 6 is a flowchart illustrating an example of a learning-model generation processing procedure of the terminal device according to the first exemplary embodiment.

FIG. 7 is a flowchart illustrating an example of a determination error distribution generation processing procedure of the terminal device according to the first exemplary embodiment.

FIG. 8 is a flowchart illustrating an example of a non-defective product determination processing procedure of the terminal device according to the first exemplary embodiment.

FIG. 9 is a diagram illustrating an example of frequency characteristic data.

FIG. 10 is a partially enlarged view of frequency characteristic data.

FIG. 11 is a diagram illustrating a comparative example of frequency characteristic data between non-defective products.

FIG. 12 is a diagram illustrating a comparative example of a low frequency region of frequency characteristic data between non-defective products.

FIG. 13 is a diagram illustrating a comparative example of a middle frequency region of frequency characteristic data between non-defective products.

FIG. 14 is a diagram illustrating a comparative example of frequency characteristic data of a non-defective product and a defective product.

FIG. 15 is a diagram for explaining an example of calculating a maximum value for each section in frequency characteristic data.

FIG. 16 is a diagram illustrating a comparative example of frequency characteristic data before and after approximation processing.

FIG. 17 is a diagram illustrating a comparative example of frequency characteristic data (input data) in a non-defective product and frequency characteristic data (output data) of a first learning model.

FIG. 18 is a diagram illustrating a comparative example of frequency characteristic data (input data) in a defective product and frequency characteristic data (output data) of the first learning model.

FIG. 19 is a diagram illustrating an example of a first determination error distribution and a second determination error distribution.

FIG. 20 is a diagram illustrating an example of a correlation between determination performance α and a bandwidth.

FIG. 21 is a correlation graph illustrating an example of a correlation between determination performance α and a bandwidth.

### DESCRIPTION OF EMBODIMENT

### Background of Present Disclosure

Conventionally, non-defective product inspection (determination), facility inspection, and the like of a product on which a motor and an actuator are mounted, the product being produced in a factory, may be performed by analyzing sound collected using a measuring instrument. However, since the collected sound includes an individual difference of the product and the facility, environmental sound (noise), and the like, it has been difficult to quantitatively perform abnormal sound evaluation. For this reason, the abnormal sound evaluation has been performed by sensory inspection using hearing of an inspector who performs non-defective product inspection of a product, facility inspection, and the like.

However, the sensory inspection has a problem in that the evaluation (inspection) result varies depending on the inspector. Furthermore, even in the evaluation (inspection) result by one inspector, there is a problem in that variations occur in the evaluation (inspection) result due to the physical condition, fatigue, and the like of the inspector.

In order to solve these problems, in the conventional Literature 1, non-defective sample data of the operation sound of the inspection target rotary machine is subjected to octave analysis, and the quality determination of the inspection target is realized on the basis of the average value of the non-defective product spectral distances using the octave band spectrum and the inspection target spectral distance based on the operation sound of the inspection target rotary machine.

However, in conventional Literature 1, since the frequency characteristics of the operation sound are calculated using a bandwidth filter having a constant ratio width close to human listening characteristics, the bandwidth is widened in a high frequency band. Therefore, in conventional Literature 1, there is a problem in that the evaluation (inspection) accuracy decreases in a case where the rotary machine is evaluated (inspected) on the basis of the difference in the noise level caused by the harmonic component of the driving frequency of the motor, the actuator, or the like.

On the other hand, in a general frequency analysis method using fast Fourier transform (FFT), a bandwidth of frequency resolution uniquely determined by a sampling frequency and the number of sampling points is narrow. Therefore, in a case where harmonic components of a driving frequency of a motor, an actuator, or the like fluctuate due to an individual difference of a product or a facility, a measurement error, or the like, a high frequency component after the fluctuation may not be evaluated in each bandwidth due to the fluctuation. Therefore, the frequency analysis method using the FFT has a problem in that the difference in the frequency characteristic increases between the products and the facilities evaluated as the non-defective product, and therefore, in a case where a machine learning model using the frequency characteristics evaluated as the non-defective product as the learning data is used, the determination accuracy between the non-defective product and the defective product in the non-defective product inspection decreases.

Hereinafter, exemplary embodiments that specifically disclose configurations and operations of a classification device, a learning-model generation device, a classification method, and a learning-model generation method according to the present disclosure will be described in detail with reference to the drawings as appropriate. It is noted that a more detailed description than need may be omitted. For example, a detailed description of an already well-known matter and a duplicated description of substantially the same configuration will be omitted in some cases. The reason for this is to avoid unnecessary redundancy of the following description and to help a person of ordinary skill in the art to achieve easy understanding. Note that the attached drawings and the following description are provided for those skilled in the art to fully understand the present invention, and are not intended to limit the subject matter described in the claims.

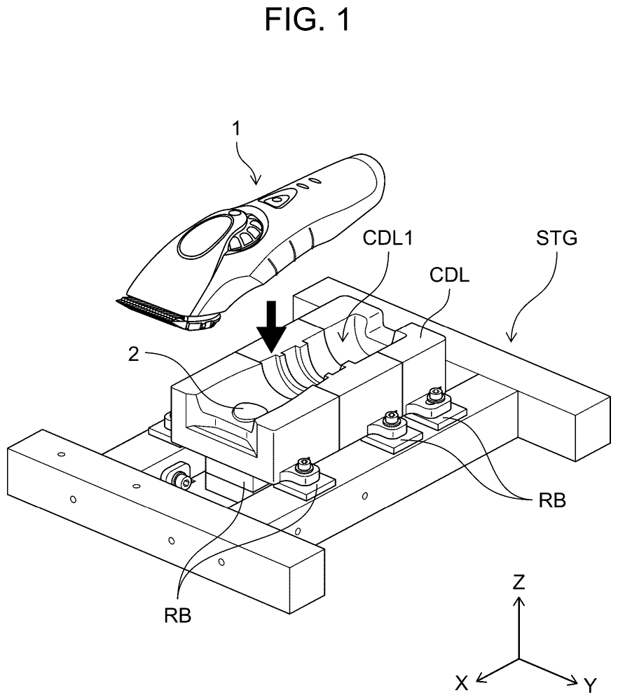

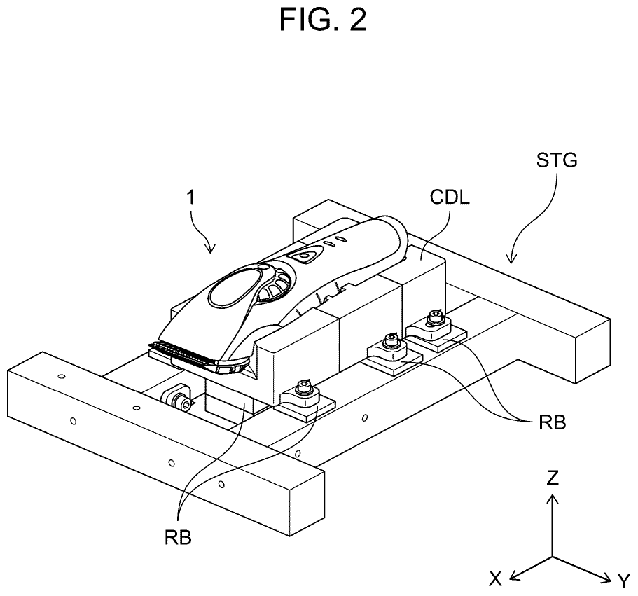

First, an example of inspection object 1 and an inspection jig will be described with reference to FIG. 1. FIG. 1 is a diagram illustrating an example of inspection object 1 and the inspection jig according to a first exemplary embodiment. FIG. 2 is a diagram illustrating an example of inspection object 1 and the inspection jig according to the first exemplary embodiment.

Note that, in the first exemplary embodiment, an example will be described as an example in which inspection object 1 is an electric shaver, but it is obvious that inspection object 1 is not limited thereto. Inspection object 1 may be a device including a drive source such as a periodically driven motor or actuator.

The inspection jig includes at least vibration sensor 2, cradle CDL, and foam rubber RB. In the inspection jig, cradle CDL that supports inspection object 1 with foam rubber RB interposed therebetween is screwed and fixed to base STG formed of a member such as aluminum.

In cradle CDL, placement surface CDL1 capable of supporting inspection object 1 is formed in accordance with the shape of inspection object 1. In cradle CDL, inspection object 1 is placed on placement surface CDL1.

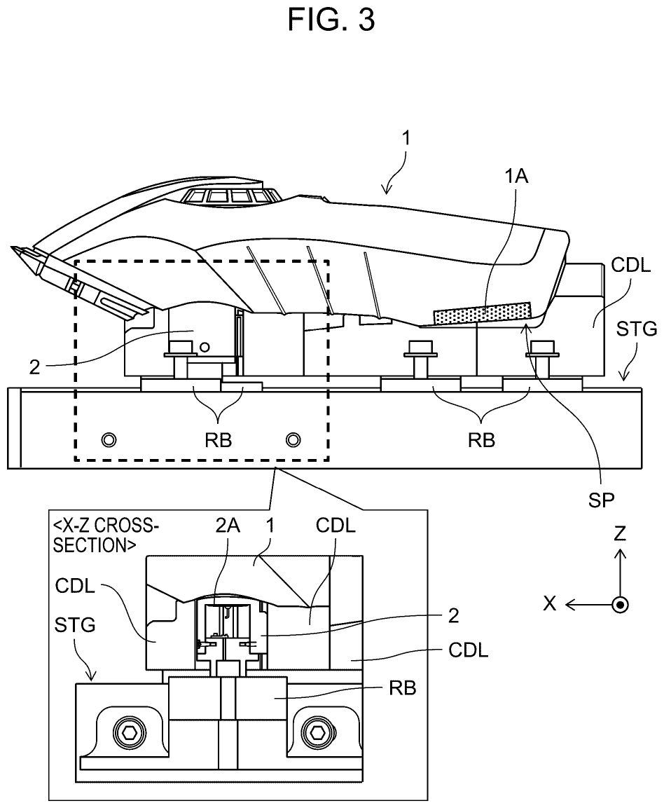

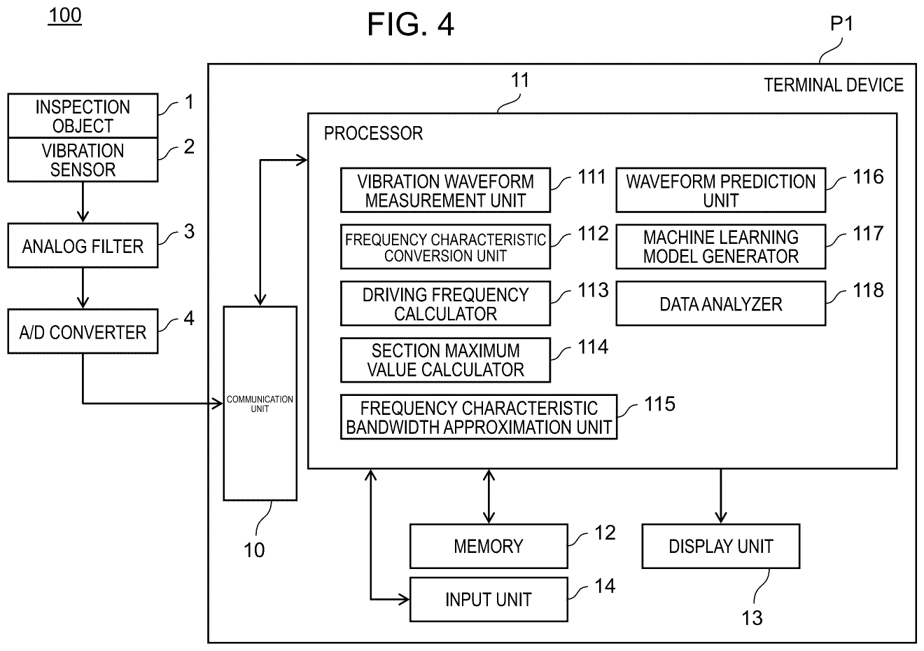

Vibration sensor 2 is built in cradle CDL in a state of being partially exposed from placement surface CDL1. In vibration sensor 2, a portion exposed from placement surface CDL1 abuts on inspection object 1. Vibration sensor 2 includes piezoelectric element 2A (see FIG. 3). Vibration sensor 2 converts drive vibration of a drive source such as a motor or an actuator of inspection object 1 into vibration data of a time-axis waveform (an example of time-axis waveform data) by using piezoelectric element 2A, and transmits the converted vibration data to analog filter 3 (see FIG. 4).

Foam rubber RB is what is called a vibration-proof rubber, and is vibration-proof so that vibration other than inspection object 1 is not transmitted to cradle CDL via base STG. As a result, vibration sensor 2 can more efficiently acquire only the drive vibration of inspection object 1.

Next, vibration sensor 2 and placement surface CDL1 of cradle CDL will be described with reference to FIG. 3. FIG. 3 is a cross-sectional view of the inspection jig taken along line X-Z.

FIG. 3 illustrates a partial cross section obtained by cutting cradle CDL in a state where inspection object 1 is placed at a substantially half position in the Y direction (width direction of inspection object 1), and a partial cross-sectional view (X-Z cross-sectional view) obtained by cutting inspection object 1 and the inspection jig at a substantially half position in the Y direction (width direction of inspection object 1).

In inspection object 1, characters, drawings, and the like are printed on print surface 1A. Placement surface CDL1 of cradle CDL is formed in a shape partially not conforming to the shape of inspection object 1 on the basis of the shape of inspection object 1 and the position of print surface 1A. A gap SP is formed between placement surface CDL1 and a surface corresponding to print surface 1A of inspection object 1 when inspection object 1 is placed, so that placement surface CDL1 is in a non-contact state with print surface 1A of inspection object 1.

As a result, the inspection jig can prevent the print quality from deteriorating due to the rubbing of print surface 1A of inspection object 1 with placement surface CDL1 due to drive vibration of inspection object 1.

Vibration sensor 2 includes piezoelectric element 2A at a portion exposed from placement surface CDL1. The vibration of inspection object 1 acquired by piezoelectric element 2A is converted into an electric signal.

Next, non-defective product determination system 100 according to the first exemplary embodiment will be described with reference to FIG. 4. FIG. 4 is a block diagram illustrating an internal configuration example of non-defective product determination system 100 according to the first exemplary embodiment. Note that non-defective product determination system 100 illustrated in FIG. 4 is an example, and is not limited thereto.

Non-defective product determination system 100 includes inspection object 1, vibration sensor 2, analog filter 3, analog/digital (A/D) converter 4, and terminal device P1 (an example of a classification device and a learning-model generation device). Note that it is obvious that non-defective product determination system 100 illustrated in FIG. 4 is an example and is not limited thereto. For example, a plurality of inspection objects 1, a plurality of vibration sensors 2, a plurality of analog filters 3, and a plurality of A/D converters 4 may be provided.

Analog filter 3 acquires vibration data (analog signal) of inspection object 1 transmitted from vibration sensor 2. Analog filter 3 executes processing of removing a frequency component unnecessary in the non-defective product determination of inspection object 1 or processing of extracting only a frequency component necessary in the non-defective product determination of inspection object 1, the frequency components being set in advance among the acquired vibration data. Analog filter 3 transmits the vibration data after execution of the above-described processing to A/D converter 4.

A/D converter 4 converts the vibration data, which is an analog signal transmitted from analog filter 3, into a digital signal. A/D converter 4 transmits the converted vibration data to communication unit 10 of terminal device P1.

Terminal device P1 is implemented by, for example, a personal computer (PC), a notebook PC, a tablet terminal, or the like. Terminal device P1 includes communication unit 10, processor 11, memory 12, display unit 13, and input unit 14. Note that input unit 14 is not an essential component and may be omitted.

Communication unit 10 (an example of an acquisition unit) is connected to A/D converter 4 so as to be able to perform wireless or wired communication. That is, an example of communication unit 10 is a connector capable of wired communication, and another example of communication unit 10 is a transmitter and a receiver capable of wireless communication. Note that the wireless communication described herein is, for example, a wireless LAN represented by Wi-Fi (registered trademark), and the type thereof is not particularly limited.

Furthermore, communication unit 10 may be connectable to an external storage medium (not illustrated) such as a compact disc read only memory (CD-ROM), a USB memory, or an SD (registered trademark) card, and may be capable of reading a learning model, vibration data of a non-defective product or a defective product, frequency characteristic data, learning data, and the like stored in the external storage medium.

Processor 11 is configured using, for example, a central processing unit (CPU) or a field programmable gate array (FPGA), and performs various types of processing and control in cooperation with memory 12. Specifically, processor 11 refers to the program and data held in memory 12 and executes the program to implement the function of each unit. Note that each unit described herein is vibration waveform measurement unit 111, frequency characteristic conversion unit 112, driving frequency calculator 113, section maximum value calculator 114, frequency characteristic bandwidth approximation unit 115, waveform prediction unit 116, machine learning model generator 117, data analyzer 118, or the like.

Vibration waveform measurement unit 111 acquires vibration data (digital signal) of the time-axis waveform output from communication unit 10 and outputs the vibration data to frequency characteristic conversion unit 112.

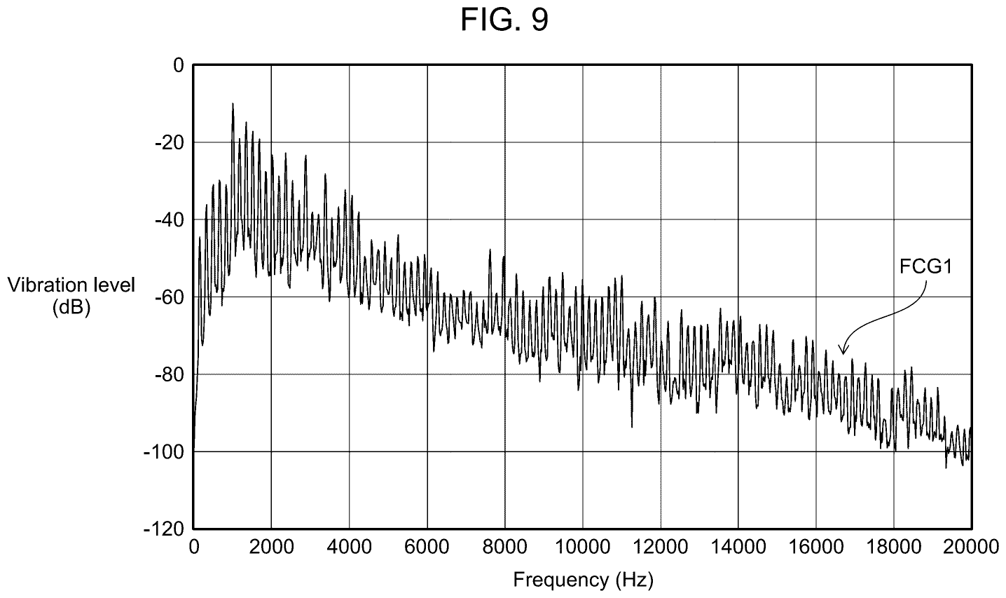

Frequency characteristic conversion unit 112 (an example of a conversion unit) executes the FFT processing on the vibration data output from vibration waveform measurement unit 111, and converts the vibration data into frequency characteristic data FCG1 (see FIG. 9). Frequency characteristic conversion unit 112 outputs frequency characteristic data FCG1 after conversion to driving frequency calculator 113.

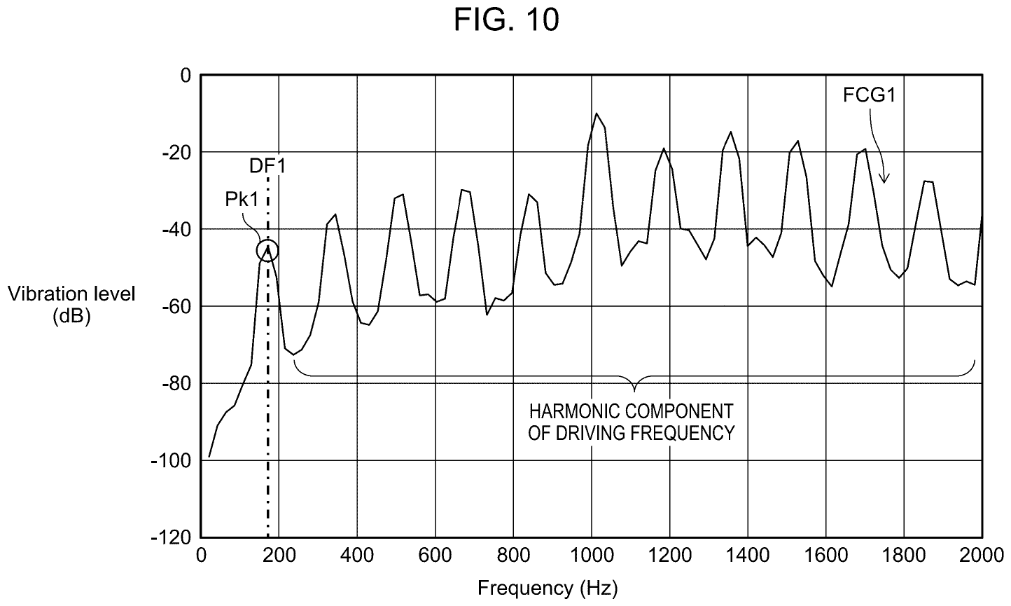

Driving frequency calculator 113 executes peak search processing on frequency characteristic data FCG1 output from frequency characteristic conversion unit 112. Driving frequency calculator 113 calculates driving frequency DF1 (see FIG. 10) of the motor, the actuator, and the like of inspection object 1 on the basis of the peak search processing result. Driving frequency calculator 113 outputs the calculated driving frequency information and frequency characteristic data FCG1 to section maximum value calculator 114.

Section maximum value calculator 114 (an example of a spectrum calculator) divides the frequency band of frequency characteristic data FCG1 with the bandwidth based on the driving frequency output from driving frequency calculator 113, and calculates the maximum value of the spectrum (dB) in each division section divided (that is, each frequency band). Section maximum value calculator 114 outputs information of the maximum value of the spectrum in each division section to frequency characteristic bandwidth approximation unit 115.

Note that, in a case where there is a frequency band in which the difference between the frequency characteristic of the non-defective product and the frequency characteristic of the defective product is sufficiently small in the frequency characteristic data, section maximum value calculator 114 may extract a frequency region other than this frequency band and divide the frequency band of frequency characteristic data FCG1 with the bandwidth. As a result, terminal device P1 can reduce processing load required for machine learning, and can more efficiently execute the non-defective product determination.

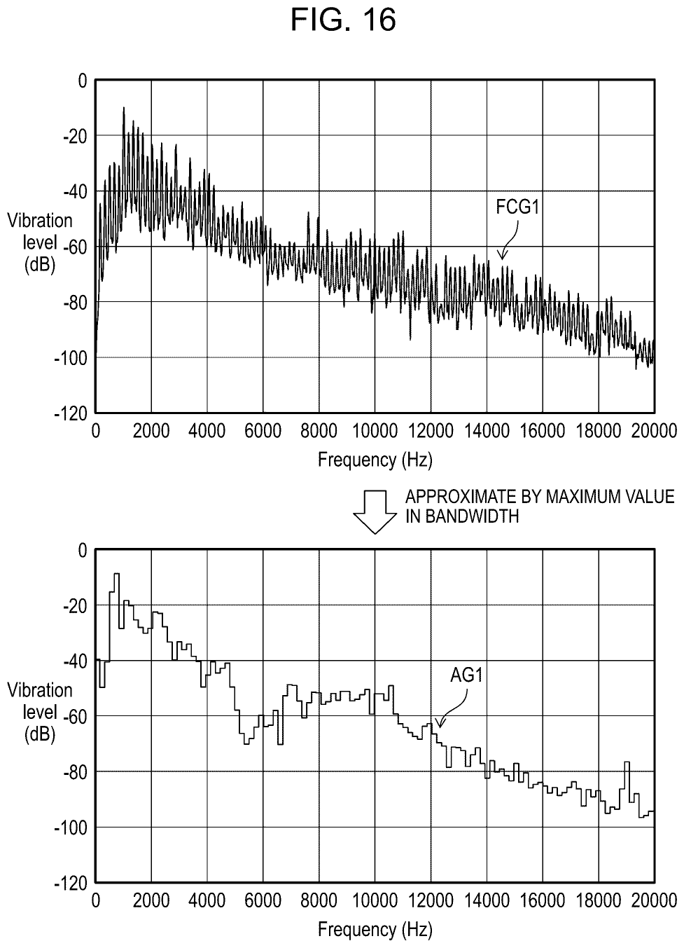

Frequency characteristic bandwidth approximation unit 115 (an example of an approximation processing unit) generates frequency characteristic data AG1 (see FIG. 16) obtained by approximating each division section of frequency characteristic data FCG1 by the maximum value of the spectrum on the basis of the information of the maximum value of the spectrum in each division section output from section maximum value calculator 114. Frequency characteristic bandwidth approximation unit 115 outputs generated frequency characteristic data AG1 to each of waveform prediction unit 116, machine learning model generator 117, and data analyzer 118, and may record frequency characteristic data AG1 in memory 12.

Note that, in the following description, frequency characteristic data AG1 approximated and generated by frequency characteristic bandwidth approximation unit 115 may be referred to as “input data” or “approximated data”. Furthermore, the approximated frequency characteristic data of the non-defective product is described as AG11, the approximated frequency characteristic data of the defective product is described as AG12, and the approximated frequency characteristic data in which the non-defective product or defective product is not specified or the non-defective product or defective product is unknown is described as AG1. Similarly, in the frequency characteristic data before approximation, the frequency characteristic data of the non-defective product is described as FCG11, the frequency characteristic data of the defective product is described as FCG12, and the frequency characteristic data is described as FCG1 in a case where the frequency characteristic data is described without specifying the non-defective product or defective product.

Machine learning model generator 117 (an example of the learning model generator) executes machine learning using one or more pieces of frequency characteristic data AG11 (approximated data) of non-defective products recorded and collected as learning data. Specifically, machine learning model generator 117 executes machine learning for determining (classifying) inspection object 1 that is a non-defective product on the basis of frequency characteristic data AG11 (approximated data) of inspection object 1 that is a non-defective product. As a result of learning, machine learning model generator 117 generates a first learning model for determining inspection object 1 that is a non-defective product, and records the first learning model in memory 12.

Examples of the statistical classification technique include linear classifiers, support vector machines, quadratic classifiers, kernel estimation, decision trees, artificial neural networks, Bayesian techniques and/or networks, hidden Markov models, binary classifiers, multi-class classifiers, clustering techniques, random forest techniques, logistic regression techniques, linear regression techniques, gradient boosting techniques, and the like. However, the statistical classification technique used is not limited thereto.

Waveform prediction unit 116 (an example of the prediction unit) inputs frequency characteristic data AG1 (input data) output from frequency characteristic bandwidth approximation unit 115 to the first learning model recorded in memory 12, and acquires frequency characteristic data FG1 (output data, predicted data) output from the first learning model. Waveform prediction unit 116 outputs acquired frequency characteristic data FG1 (output data, predicted data) to data analyzer 118.

Note that waveform prediction unit 116 acquires frequency characteristic data FG11 output from the first learning model when frequency characteristic data AG11 of a non-defective product is input, and acquires frequency characteristic data FG12 output from the first learning model when frequency characteristic data AG12 of a defective product is input.

Note that, in the following description, frequency characteristic data FG1, FG11, FG12 input to and output from each learning model may be referred to as “output data” or “predicted data”.

Data analyzer 118 (an example of a classification unit) calculates a mean square error between frequency characteristic data AG1 (input data) output from frequency characteristic bandwidth approximation unit 115 and frequency characteristic data FG1 (output data) output from waveform prediction unit 116 and output from the first learning model. Data analyzer 118 determines whether or not inspection object 1 is a non-defective product (that is, whether or not inspection object 1 is classified as a non-defective product) on the basis of the calculated mean square error, first determination error distribution GDD, and second determination error distribution BDD.

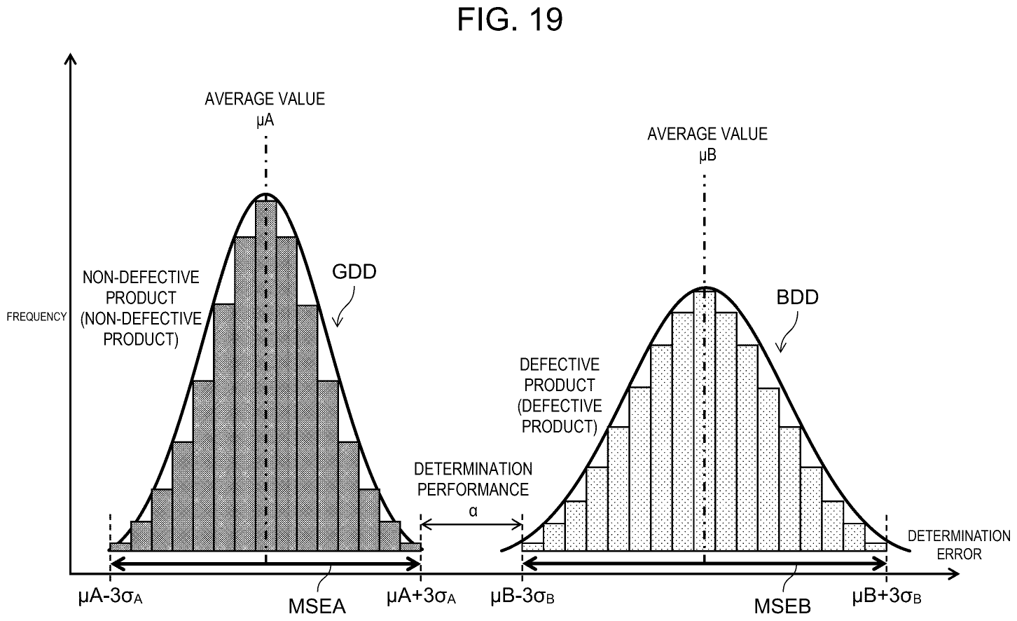

Here, first determination error distribution GDD is generated by data analyzer 118 on the basis of a plurality of pieces of frequency characteristic data AG11 (approximated data), which are known to be non-defective products in advance, and a plurality of pieces of frequency characteristic data FG11 (output data) output from the first learning model, and is, for example, a histogram of first determination error distribution GDD illustrated in FIG. 19 or the like.

Furthermore, second determination error distribution BDD is generated by data analyzer 118 on the basis of a plurality of pieces of frequency characteristic data AG12 (approximated data), which are known to be defective products in advance, and a plurality of pieces of frequency characteristic data FG12 (output data) output from the first learning model, and is, for example, a histogram of second determination error distribution BDD illustrated in FIG. 19 or the like.

Note that, although data analyzer 118 determines whether or not inspection object 1 is a non-defective product using first determination error distribution GDD and second determination error distribution BDD, the determination may be made using only first determination error distribution GDD, or the determination may be made on the basis of whether or not the calculated mean square error is within a predetermined threshold.

Data analyzer 118 generates an inspection (classification) result indicating whether inspection object 1 is a non-defective product or a defective product, and outputs the inspection result to display unit 13 to cause display unit 13 to display the inspection result. Furthermore, data analyzer 118 may output the generated histogram or the like and the calculated mean square error to display unit 13 to cause display unit 13 to display the histogram or the like, and the user may determine whether inspection object 1 is a non-defective product.

Memory 12 (an example of a storage) has a storage device including a semiconductor memory such as a random access memory (RAM) and a read only memory (ROM), and any device of a storage device such as a solid state drive (SSD) or an HDD. Memory 12 stores vibration data of a non-defective product or a defective product, learning data, the first learning model generated by machine learning model generator 117, first determination error distribution GDD, second determination error distribution BDD, and the like.

Display unit 13 is configured using, for example, a display such as a liquid crystal display (LCD) or an organic electroluminescence (EL). Display unit 13 displays a determination (classification) result, a notification such as a histogram, and data output from processor 11.

Input unit 14 can receive a user operation, and is a user interface configured using, for example, a mouse, a keyboard, a touch panel, or the like. Input unit 14 converts the received user operation into an electric signal (control command) and outputs the electric signal to processor 11.

Note that non-defective product determination system 100 according to the first exemplary embodiment may be configured to analyze the vibration data acquired from each of a plurality of the inspection objects by one terminal device P1 and execute each of the machine learning processing and the non-defective product determination processing. As a result, non-defective product determination system 100 can more efficiently collect and learn the learning data used for machine learning.

Furthermore, terminal device P1 of non-defective product determination system 100 may be implemented by, for example, a cloud server or the like. In such a case, the cloud server acquires the vibration data of at least one inspection object 1 via a network (not illustrated) connected so as to be able to perform wireless communication or wired communication. The cloud server analyzes the acquired vibration data and executes each of the machine learning processing and the non-defective product determination processing. Note that the cloud server may transmit the non-defective product determination result to another terminal device managed by the worker who inspects inspection object 1 and cause the other terminal device to display the non-defective product determination result.

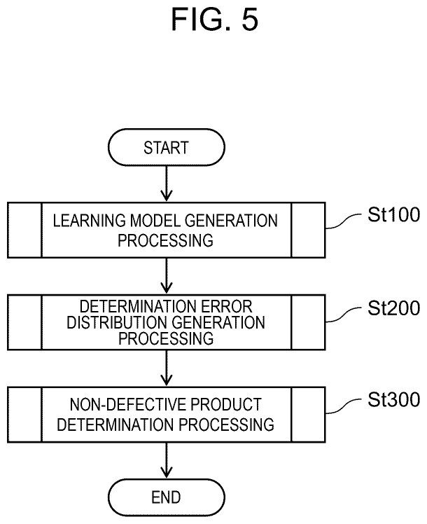

Next, an overall operation procedure of terminal device P1 will be described with reference to FIG. 5. FIG. 5 is a flowchart illustrating an example of an overall operation procedure of terminal device P1 in the first exemplary embodiment.

Note that FIG. 5 illustrates an example in which learning model generation processing (step St100), determination error distribution generation processing (step St200), and non-defective product determination processing (step St300) are performed as a series of processing (flow), but these pieces of processing may be each completed as one independent flow.

For example, the learning model generation processing (step St100), the determination error distribution generation processing (step St200), and the non-defective product determination processing (step St300) may be executed by one or more different terminal devices P1. Furthermore, data (learning model, determination error distribution) generated in each piece of processing may be optionally shared among a plurality of different terminal devices P1. Specifically, terminal device P1 may acquire data of the first learning model generated in advance and first determination error distribution GDD from another terminal device, an external storage medium, or the like, and execute the non-defective product inspection (determination) of inspection object 1 using the acquired first learning model and first determination error distribution GDD.

Terminal device P1 executes the machine learning using frequency characteristic data AG11 (approximated data) based on each of the plurality of pieces of vibration data collected from inspection object 1 that is a non-defective product, and generates the first learning model for determining inspection object 1 that is a non-defective product (St100).

Terminal device P1 calculates a mean square error between frequency characteristic data AG11 (approximated data) and frequency characteristic data FG11 (output data) of inspection object 1 that is a non-defective product using frequency characteristic data AG11 (approximated data) based on each of the plurality of pieces of vibration data collected from the plurality of inspection objects 1 that are non-defective products and frequency characteristic data FG11 (output data) of the non-defective product obtained (output) by inputting frequency characteristic data AG11 (approximated data) to the first learning model. Terminal device P1 generates first determination error distribution GDD (see FIG. 19) of inspection object 1 that is a non-defective product on the basis of the calculated mean square error (St200). Note that the first learning model used here may be acquired from another terminal device, an external storage medium, or the like.

Terminal device P1 calculates a mean square error between frequency characteristic data AG11 (approximated data) of inspection object 1 and frequency characteristic data FG1 (output data) of inspection object 1 output from the first learning model, and determines whether or not inspection object 1 is a non-defective product (that is, whether or not inspection object 1 is classified as a non-defective product) on the basis of the calculated mean square error and first determination error distribution GDD (St300). Note that the first learning model used here may be acquired from another terminal device, an external storage medium, or the like.

As described above, terminal device P1 according to the first exemplary embodiment can execute the non-defective product determination of inspection object 1. Note that the processing of step St100 may be omitted in a case where there is a first learning model learned in advance, a case where a first learning model generated in advance in another terminal device or the like is acquired and used, or the like. Furthermore, the processing of step St200 may be omitted in a case where there is first determination error distribution GDD generated in advance, a case where first determination error distribution GDD generated in advance in another terminal device or the like is acquired and used, or the like.

Furthermore, if terminal device P1 determines that inspection object 1 is a non-defective product as a result of the processing of step St300, terminal device P1 may further execute the machine learning using the frequency characteristic data (approximated data) of inspection object 1 (a non-defective product) to update the first learning model.

As a result, terminal device P1 can more efficiently execute the non-defective product determination (inspection) of inspection object 1 and the update of the first learning model for executing the non-defective product determination of inspection object 1.

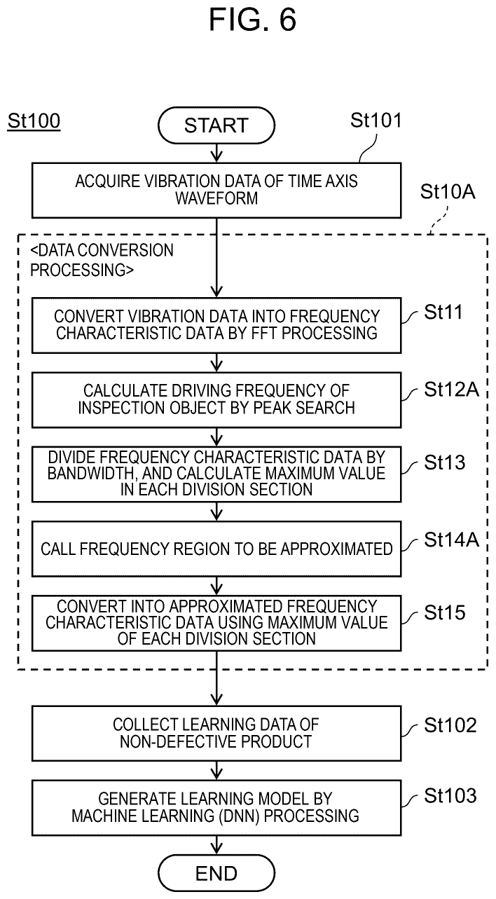

Next, the learning model generation processing (step St100) illustrated in FIG. 5 will be described with reference to FIG. 6. FIG. 6 is a flowchart illustrating an example of a learning model generation processing procedure of terminal device P1 in the first exemplary embodiment. Note that, here, the learning is performed using the vibration data of inspection object 1 that is determined to be a non-defective product as described above.

Terminal device P1 acquires vibration data (digital signal) of the time-axis waveform of inspection object 1 (St101).

Terminal device P1 executes the FFT processing on the acquired vibration data and converts the vibration data into frequency characteristic data FCG1 (see FIG. 9) (St11).

Terminal device P1 calculates driving frequency DF1 (see FIG. 10) of inspection object 1 from frequency characteristic data FCG1 by the peak search processing (St12A). Terminal device P1 records calculated driving frequency DF1 in memory 12 in association with information of inspection object 1 (for example, the type, product name, model number, and the like of inspection object 1).

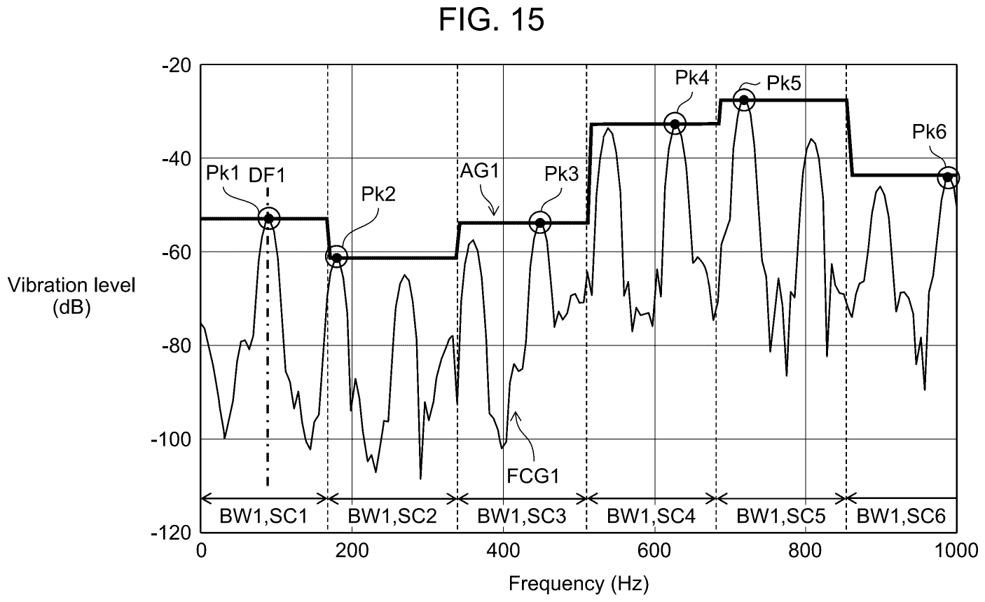

Terminal device P1 divides frequency characteristic data FCG1 for each bandwidth BW1 (see FIG. 15), and calculates the maximum value of the spectrum in each division section divided (St13).

Terminal device P1 determines a frequency region that is a target of approximation processing approximated by the maximum value of each division section (St14A).

Terminal device P1 performs the approximation processing on the frequency region to be subjected to the approximation processing using the maximum value of the vibration data in each division section, and converts frequency characteristic data FCG1 into frequency characteristic data AG11 (approximated data) (St15).

Terminal device P1 repeatedly executes the processing of steps St11 to St15 for each vibration waveform determined to be a non-defective product, and records and collects frequency characteristic data AG11 (approximated data) after the conversion in memory 12 as learning data used for machine learning for generating a learning model (St102).

Terminal device P1 executes machine learning (DNN) processing using a plurality of pieces of the collected learning data (frequency characteristic data AG11 (approximated data)) and generates a first learning model (St103).

As described above, terminal device P1 according to the first exemplary embodiment generates the first learning model. Note that terminal device P1 can also perform generation processing of a second learning model from the vibration waveform determined to be a defective product, and can generate the second learning model by a similar procedure.

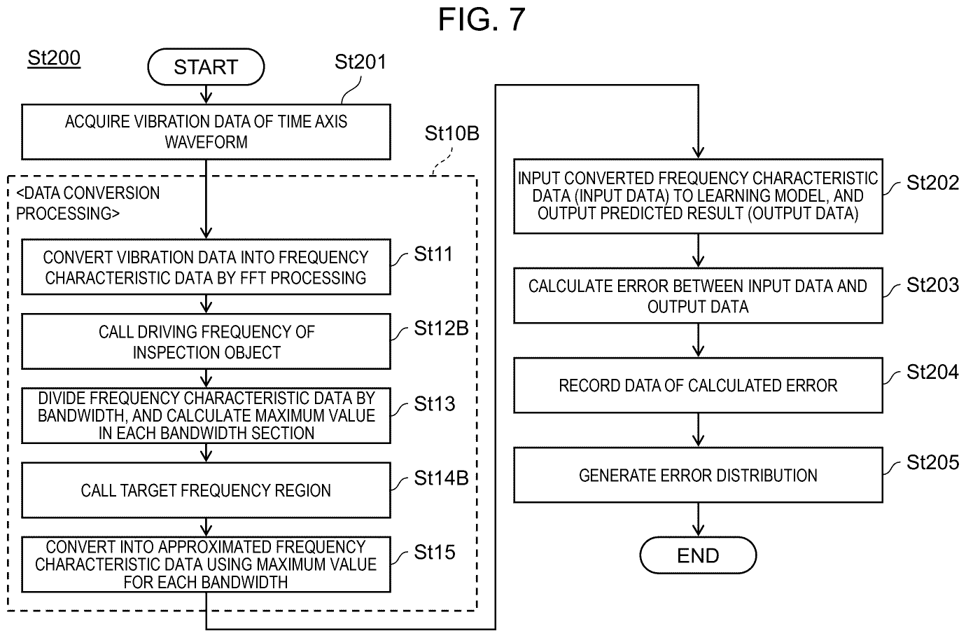

Next, the determination error distribution generation processing (step St200) illustrated in FIG. 5 will be described with reference to FIG. 7. FIG. 7 is a flowchart illustrating an example of the determination error distribution generation processing procedure of terminal device P1 according to the first exemplary embodiment. Note that, since the data conversion processing (step St10B) illustrated in FIG. 7 is substantially similar to the data conversion processing (step St10A) described in FIG. 6, only different processing will be described.

Terminal device P1 acquires vibration data (digital signal) of the time-axis waveform of inspection object 1 (St201).

Terminal device P1 executes the FFT processing on the acquired vibration data, converts the vibration data into frequency characteristic data FCG1 (see FIG. 9) (St11), and reads driving frequency DF1 (see FIG. 10) of inspection object 1 recorded in memory 12 on the basis of the information of inspection object 1 (for example, the type, product name, model number, and the like of inspection object 1) (St12B). Furthermore, terminal device P1 reads a frequency region that is a target of approximation processing approximated by the maximum value of each division section on the basis of the information of inspection object 1 (for example, the type, product name, model number, and the like of inspection object 1) (St14B).

Terminal device P1 inputs approximated frequency characteristic data AG1 (input data) to the first learning model. Terminal device P1 acquires frequency characteristic data FG1 (output data, predicted data) output from the first learning model (St202).

Terminal device P1 calculates a mean square error between frequency characteristic data AG1 (input data) and frequency characteristic data FG1 (output data) output from the first learning model (St203). Terminal device P1 records and collects the calculated data of the mean square error in memory 12 (St204).

Terminal device P1 generates first determination error distribution GDD and second determination error distribution BDD (see FIG. 19) of inspection object 1 that is a non-defective product on the basis of the data of a plurality of the mean square errors recorded in memory 12 and collected from inspection object 1 that is a non-defective product (St205).

As described above, terminal device P1 according to the first exemplary embodiment can generate first determination error distribution GDD and second determination error distribution BDD capable of determining whether or not inspection object 1 is a non-defective product (that is, whether or not inspection object 1 is classified as a non-defective product) on the basis of the mean square error.

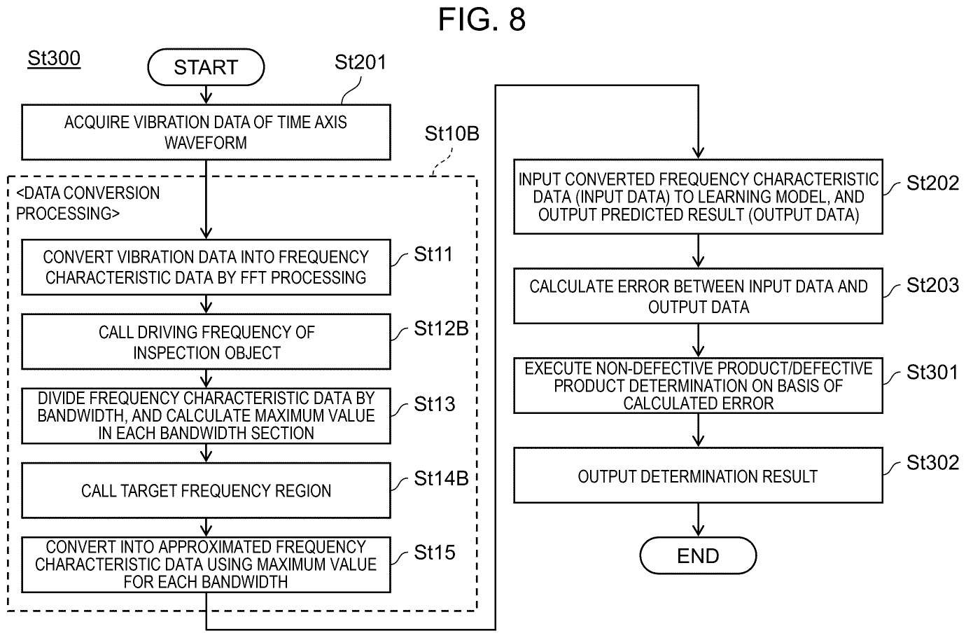

Next, the non-defective product determination processing (step St300) illustrated in FIG. 5 will be described with reference to FIG. 8. FIG. 8 is a flowchart illustrating an example of a non-defective product determination processing procedure of terminal device P1 according to the first exemplary embodiment.

Note that the processing of each of steps St201 to St203 illustrated in FIG. 8 is similar to the processing of a respective one of steps St201 to St203 described in FIG. 7, and thus description thereof is omitted. Furthermore, since the data conversion processing (step St10B) illustrated in FIG. 8 is substantially similar to the data conversion processing (step St10B) described in FIG. 7, the description thereof will be omitted.

Terminal device P1 determines whether or not inspection object 1 is a non-defective product (that is, whether or not inspection object 1 is classified as a non-defective product) on the basis of whether or not the mean square error between frequency characteristic data AG1 (input data) and frequency characteristic data FG1 (output data) calculated by the processing of step St203 is within the determination error (μA−3σ_{A}) to the determination error (μA+3σ_{A}), inclusive, of first determination error distribution GDD of a non-defective product (St301), and outputs the determination result to display unit 13 (St302).

Note that, here, if terminal device P1 determines that the mean square error calculated by the processing of step St203 is within the determination error (μA−3σ_{A}) to the determination error (μA+3σ_{A}), inclusive, terminal device P1 determines that inspection object 1 is a non-defective product (that is, inspection object 1 is classified as a non-defective product). On the other hand, if terminal device P1 determines that the mean square error calculated by the processing of step St203 is not within the determination error (μA−3σ_{A}) to the determination error (μA+3σ_{A}), inclusive, terminal device P1 determines that inspection object 1 is not a non-defective product (that is, inspection object 1 is not classified as a non-defective product).

As described above, terminal device P1 according to the first exemplary embodiment divides frequency characteristic data FCG1 by the bandwidth based on the driving frequency of inspection object 1, and approximates frequency characteristic data FCG1 on the basis of the maximum value of the spectrum in the division section divided, so that the non-defective product determination (classification determination) of inspection object 1 can be executed regardless of an individual difference of the drive source such as the motor or the actuator included in inspection object 1.

Furthermore, as a result, terminal device P1 can suppress erroneous determination of the individual difference non-defective product determination (classification determination) of inspection objects 1 of the non-defective products, and improve the determination accuracy of the non-defective product determination.

Next, frequency characteristic data FCG1 of inspection object 1 will be described with reference to each of FIGS. 9 and 10. FIG. 9 is a diagram illustrating an example of frequency characteristic data FCG1. FIG. 10 is a partially enlarged view of frequency characteristic data FCG1.

Frequency characteristic data FCG1 is generated by frequency characteristic conversion unit 112, and is a graph illustrating the frequency characteristic of a drive source such as a motor and an actuator of inspection object 1, the frequency characteristic being obtained by performing the FFT processing on vibration data (digital signal) of the time-axis waveform of inspection object 1.

The drive source included in inspection object 1 is driven at a predetermined cycle. As a result, frequency characteristic data FCG1 shows a complex frequency characteristic in which harmonic components of the driving frequency are superimposed on the frequency characteristic unique to the drive source at substantially equal intervals, and each of the harmonic components forms a spectrum peak. Furthermore, the superposition of the harmonic components is formed over a high frequency band.

Frequency characteristic data FCG1 illustrated in FIG. 10 is a partially enlarged view of frequency characteristic data FCG1 illustrated in FIG. 9. Driving frequency calculator 113 detects driving frequency DF1=180 Hz of inspection object 1 from frequency characteristic data FCG1 by the peak search processing.

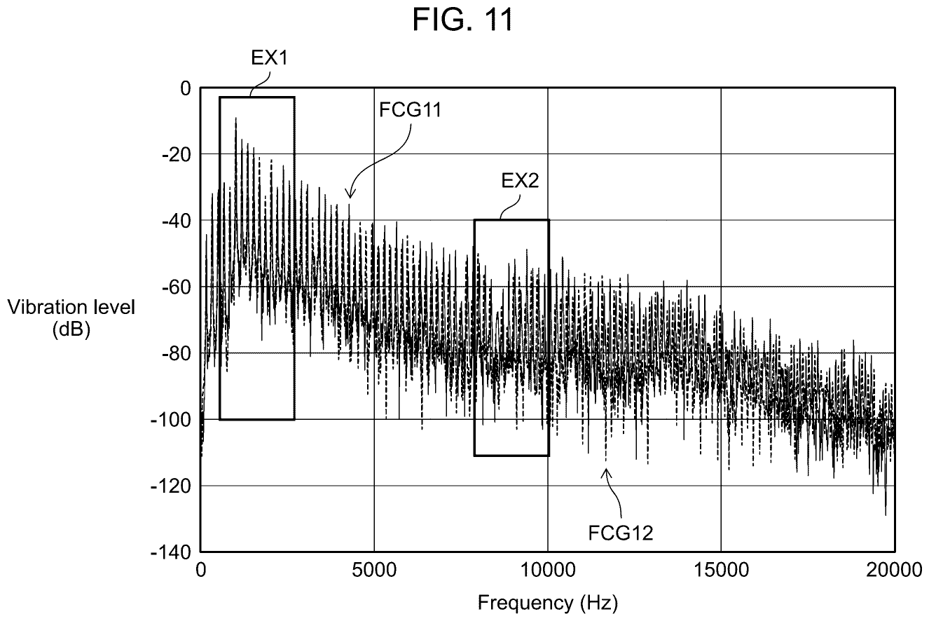

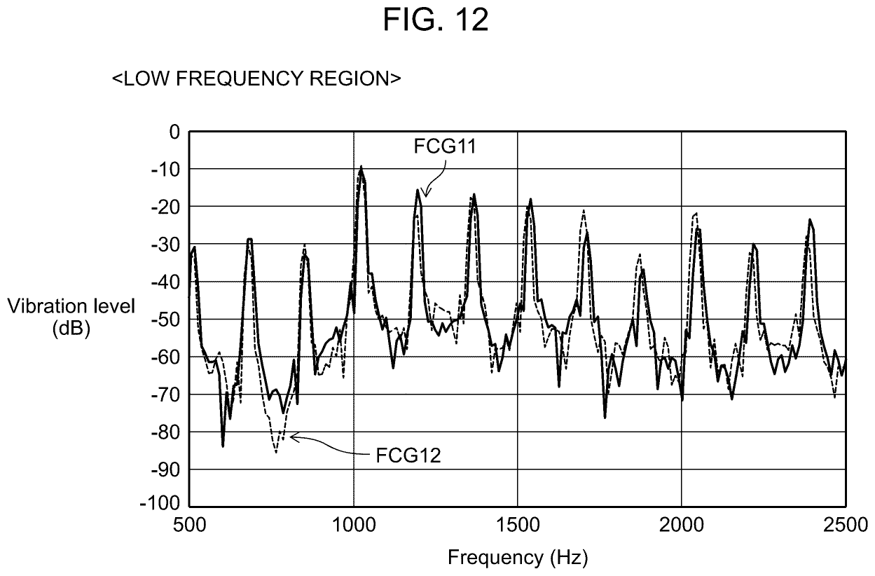

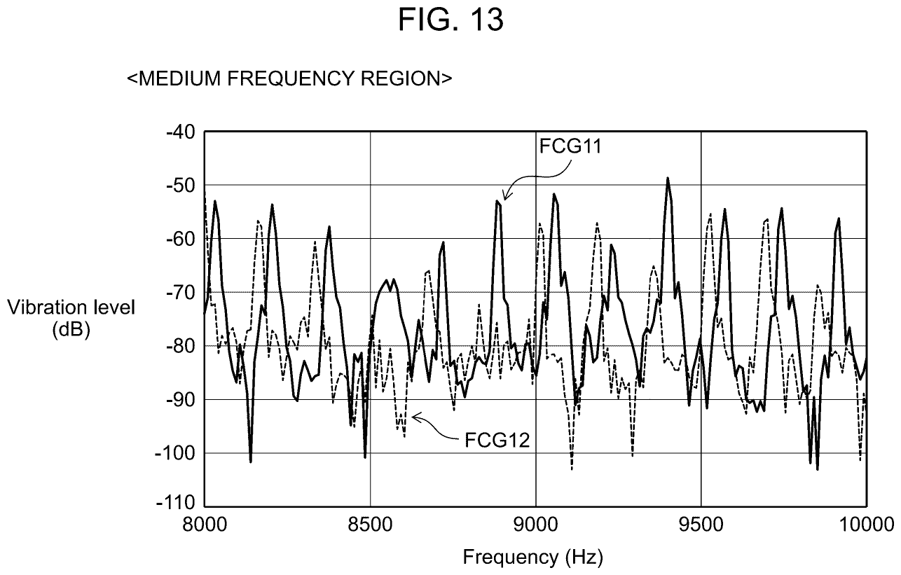

Next, an individual difference of the frequency characteristic data of inspection object 1 that is a non-defective product will be described with reference to each of FIGS. 11 to 13. FIG. 11 is a diagram illustrating a comparative example of frequency characteristic data FCG11, FCG12 of the non-defective products. FIG. 12 is a diagram illustrating a comparative example of low frequency region EX1 of frequency characteristic data FCG11, FCG12 of the non-defective products. FIG. 13 is a diagram illustrating a comparative example of middle frequency region EX2 of frequency characteristic data FCG11, FCG12 of the non-defective products.

Each of frequency characteristic data FCG11, FCG12 is a graph of frequency characteristic data obtained by performing the FFT processing on the vibration data acquired from a respective one of two inspection objects 1 determined to be non-defective products. In each of frequency characteristic data FCG11, FCG12, the peaks of harmonic components generated at substantially equal multiples of driving frequency DF1 in low frequency region EX1 substantially coincide with each other, but there is a difference in frequencies at which the peaks of harmonic components are formed in middle frequency region EX2.

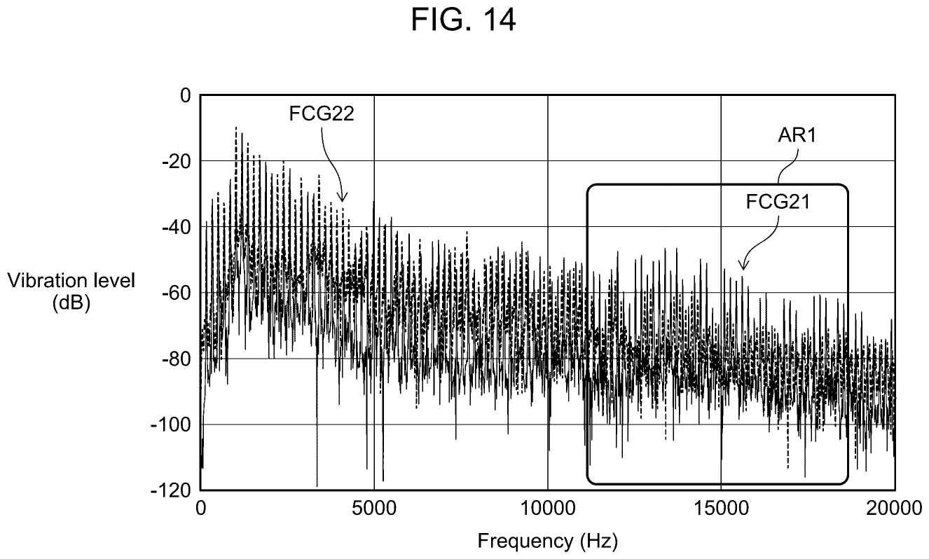

Furthermore, the frequency characteristic data of inspection object 1 that is a non-defective product and the frequency characteristic data of inspection object 1 that is a defective product will be described with reference to FIG. 14. FIG. 14 is a diagram illustrating a comparative example of each of the frequency characteristic data of a non-defective product and a defective product.

Frequency characteristic data FCG21 indicates the frequency characteristic data of inspection object 1 that is a non-defective product. Furthermore, frequency characteristic data FCG22 indicates the frequency characteristic data of inspection object 1 that is a defective product.

In each of frequency characteristic data FCG21, FCG22, the peaks of harmonic components generated at substantially equal multiples of driving frequency DF1 in the low frequency region substantially coincide with each other, but a difference in the frequencies at which the peaks of the harmonic components are formed becomes large in the middle frequency region and the high frequency region (region AR1 illustrated in FIG. 14).

Therefore, in terminal device P1, in the machine learning processing of generating the learning model (the first learning model or the second learning model) for determining the non-defective product or the defective product, when the magnitudes of the spectra are compared for each frequency, there is a possibility that the deviation of the frequencies at which the peaks of the harmonic components are formed in inspection objects 1 that are non-defective products cancels the difference in the spectra between inspection object 1 that is a non-defective product and inspection object 1 that is a defective product in the middle frequency region and the high frequency region, and the determination accuracy in the non-defective product determination decreases.

Therefore, terminal device P1 according to the first exemplary embodiment divides the frequency characteristic data with the bandwidth as described above, and approximates the frequency characteristic data by the maximum value of the spectrum of each division section divided, so that the learning data in which the deviation of the peak position of the harmonic component is ignored can be generated. Hereinafter, an approximation example of the frequency characteristic data will be specifically described.

Next, a method of calculating the maximum value of the spectrum in the division section will be described with reference to each of FIGS. 15 and 16. FIG. 15 is a diagram for explaining an example of calculating the maximum value for each division section in frequency characteristic data FCG1. FIG. 16 is a diagram illustrating a comparative example of frequency characteristic data FCG1 before and after the approximation processing.

An example will be described in which frequency characteristic data FCG1 illustrated in FIG. 15 is driving frequency DF1=180 Hz, but it is obvious that the driving frequency is an example and is not limited thereto.

Bandwidth BW1 is determined on the basis of driving frequency DF1. Bandwidth BW1 is set to a value larger than driving frequency DF1=180 Hz and smaller than driving frequency DF1×2=360 Hz. An example will be described in which bandwidth BW1 in the first exemplary embodiment is set to the following example: sampling frequency 44100 Hz÷sampling point 4096×N number 32=345 Hz.

As a result, in terminal device P1, each of division sections SC1 to SC6 divided by the bandwidth BW1 includes a maximum of two peaks of harmonic components of the driving frequency. For example, in the example illustrated in FIG. 15, division section SC1 includes one peak. Each of division sections SC2 to SC6 includes two peaks. Note that the number of peaks included in each division section is only required to be at least one.

Terminal device P1 calculates each of peaks Pk1, Pk2, Pk3, Pk4, Pk5, Pk6, which are the maximum values of the spectrum of each division section, and converts frequency characteristic data FCG1 into frequency characteristic data AG1 by approximating the corresponding division section on the basis of a respective one of calculated peaks Pk1 to Pk6. As a result, frequency characteristic data FCG1 is converted into frequency characteristic data AG1 having a spectrum that is indicated in a stepwise manner.

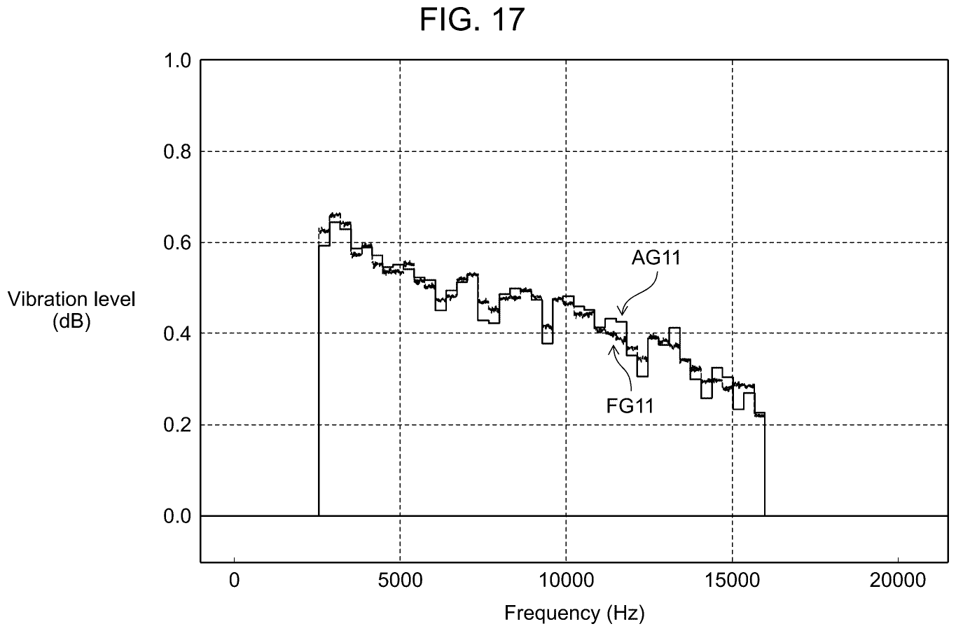

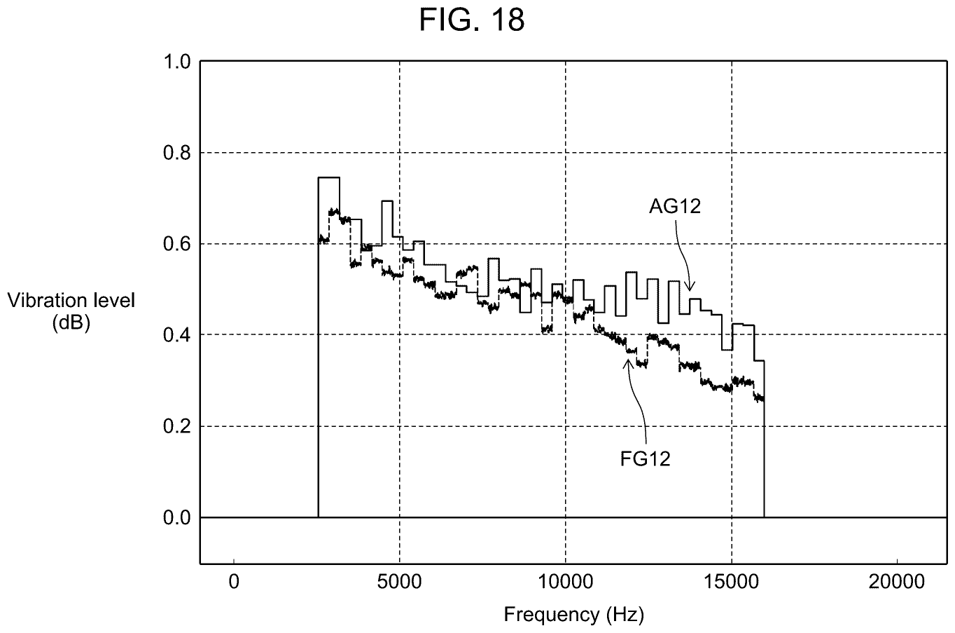

Next, frequency characteristic data (output data) output by the first learning model will be described with reference to each of FIGS. 17 and 18. FIG. 17 is a diagram illustrating a comparative example of the input data (frequency characteristic data AG11) of the non-defective product and the predicted data (frequency characteristic data FG11) by the first learning model. FIG. 18 is a diagram illustrating a comparative example of the input data (frequency characteristic data AG12) of the defective product and the predicted data (frequency characteristic data FG12) by the first learning model. Note that, here, an example will be described in which inspection object 1 is a non-defective product.

In FIG. 17, frequency characteristic data AG11 is approximated data of inspection object 1 that is a non-defective product. Frequency characteristic data AG11 is input to the first learning model as input data and frequency characteristic data FG11 is output data (predicted data) output from the first learning model. In FIG. 18, frequency characteristic data AG12 is approximated data of inspection object 1 that is a defective product. Frequency characteristic data AG12 is input to the first learning model as input data and frequency characteristic data FG12 is output data (predicted data) output from the first learning model.

The spectrums of frequency characteristic data AG11 of the non-defective product and frequency characteristic data FG11 output by the first learning model generated using the frequency characteristic data (approximated data) of the non-defective product coincides with each other more than the spectrums of frequency characteristic data AG12 of the defective product and frequency characteristic data FG12 output by the first learning model generated using the frequency characteristic data (approximated data) of the non-defective product.

As a result, terminal device P1 can determine whether or not inspection object 1 is a non-defective product (that is, whether or not inspection object 1 is classified as a non-defective product) by evaluating the mean square error in the frequency band between the input data and the predicted data (output data) as a determination error in frequency characteristic data AG1.

Next, a mean square error will be described with reference to FIG. 19. FIG. 19 is a diagram illustrating an example of first determination error distribution GDD and second determination error distribution BDD.

First determination error distribution GDD indicates a normal distribution of the mean square error between frequency characteristic data AG11 (input data) of the non-defective product and frequency characteristic data FG11 (output data) output from the first learning model. Determination error range MSEA indicates a range from the determination error (μA−3σ_{A}) to the determination error (μA+3σ_{A}), inclusive, centered on the average value μA of the determination errors. Note that, σ_{A} described herein is the standard deviation σ_{A} of first determination error distribution GDD.

Second determination error distribution BDD indicates a normal distribution of the mean square error between frequency characteristic data AG12 (input data) of the defective product and frequency characteristic data FG12 (output data) output from the first learning model. Determination error range MSEB indicates a range from the determination error (μB−3σ_{B}) to the determination error (μB+3σ_{B}), inclusive, centered on the average value μB of the determination errors. Note that, σ_{B} described herein is the standard deviation σ_{B} of second determination error distribution BDD.

Determination performance α indicates a difference between the determination error (μA−3σ_{A}) of first determination error distribution GDD and the determination error (μB−3σ_{B}) of second determination error distribution BDD.

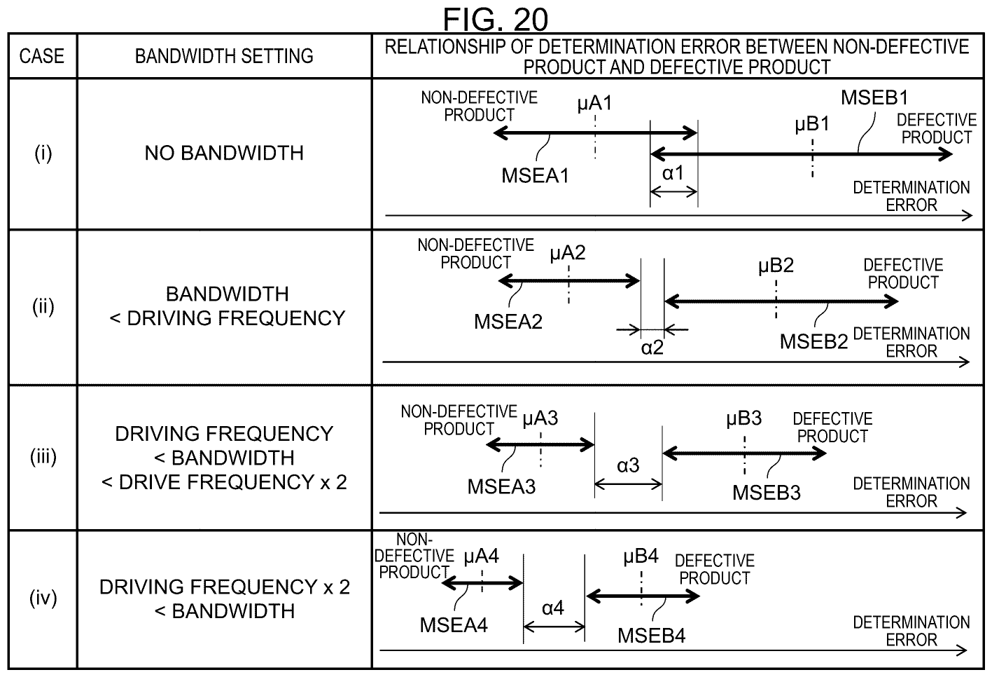

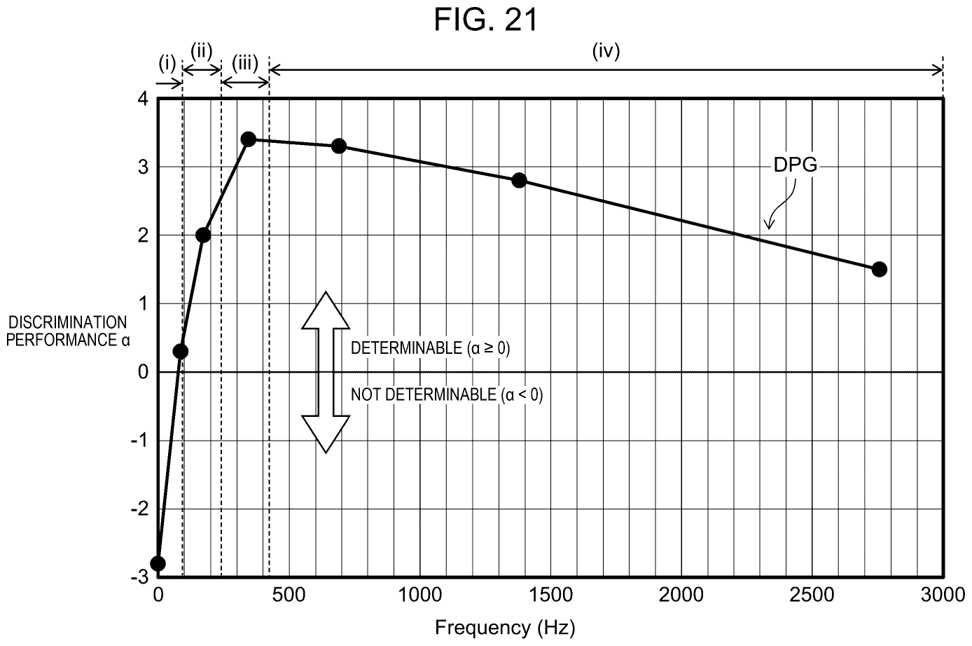

Next, determination performance α will be described with reference to each of FIGS. 20 and 21. FIG. 20 is a diagram illustrating an example of a correlation between the determination performance and a bandwidth. FIG. 21 is correlation graph DPG illustrating an example of a correlation between the determination performance and a bandwidth. Note that, In FIGS. 20 and 21, the correlation between the determination performance and the bandwidth in a case where driving frequency DF1=180 Hz will be described as an example.

First, determination performance α1 in a case where bandwidth BW1 is not set in case (i) will be described.

In the first determination error distribution (not illustrated), a range from the determination error (μA−3σ_{A}) to the determination error (μA+3σ_{A}), inclusive, centered on the average value μA1 of the determination errors is determination error range MSEA1. Furthermore, similarly, in the second determination error distribution (not illustrated), a range from the determination error (μB−3σ_{B}) to the determination error (μB+3σ_{B}), inclusive, centered on the average value μB1 of the determination errors is determination error range MSEB1. In such a case, the standard deviation σ_{A} of the first determination error distribution determined to be the non-defective product and the standard deviation σ_{B} of the second determination error distribution determined to be the defective product become large, and determination error range MSEA1 of the first determination error distribution and determination error range MSEB1 of the second determination error distribution overlap.

Therefore, in a case where bandwidth BW1 is not set, determination performance α1<0, and erroneous determination occurs in this overlapping region, so that terminal device P1 cannot determine whether inspection object 1 is a non-defective product or a defective product on the basis of the mean square error.

Next, determination performance α2 in a case where a bandwidth satisfying the driving frequency >the bandwidth in case (ii) is set will be described.

In the first determination error distribution (not illustrated), a range from the determination error (μA−3σ_{A}) to the determination error (μA+3σ_{A}), inclusive, centered on the average value μA2 of the determination errors is determination error range MSEA2. Furthermore, similarly, in the second determination error distribution (not illustrated), a range from the determination error (μB−3σ_{B} ) to the determination error (μB+3σ_{B}), inclusive, centered on the average value μB2 of the determination errors is determination error range MSEB2. In such a case, standard deviation σ_{A} of the first determination error distribution determined to be the non-defective product and standard deviation σ_{B} of the second determination error distribution determined to be the defective product become small, and determination error range MSEA2 of the first determination error distribution and determination error range MSEB2 of the second determination error distribution do not overlap.

Therefore, in a case where a bandwidth satisfying driving frequency DF1(=180 Hz)>the bandwidth is set, determination performance α2>0, and a difference is generated between determination error range MSEA2 and determination error range MSEB2, so that terminal device P1 can determine whether inspection object 1 is a non-defective product or a defective product on the basis of the mean square error.

Next, determination performance α3 in a case where a bandwidth satisfying driving frequency DF1(=180 Hz)<the bandwidth<driving frequency DF1×2(=360 Hz) is set in case (iii) will be described.

In the first determination error distribution (not illustrated), a range from the determination error (μA−3σ_{A}) to the determination error (μA+3σ_{A}), inclusive, centered on the average value μA3 of the determination errors is determination error range MSEA3. Furthermore, similarly, in the second determination error distribution (not illustrated), a range from the determination error (μB−3σ_{B}) to the determination error (μB+3σ_{B}), inclusive, centered on the average value μB3 of the determination errors is determination error range MSEB3. In such a case, standard deviation σ_{A} of the first determination error distribution determined to be the non-defective product and standard deviation σ_{B} of the second determination error distribution determined to be the defective product become smaller, and determination error range MSEA3 of the first determination error distribution and determination error range MSEB3 of the second determination error distribution are further separated.

Therefore, in a case where a bandwidth satisfying driving frequency DF1(=180 Hz)<the bandwidth<driving frequency DF1×2(=360 Hz) is set, determination performance α3>determination performance α2, and a difference is generated between determination error range MSEA3 and determination error range MSEB3, so that terminal device P1 can determine whether inspection object 1 is a non-defective product or a defective product with higher accuracy on the basis of the mean square error.

Next, determination performance α4 in a case where a bandwidth satisfying driving frequency DF1×2(=360 Hz)<the bandwidth in case (iv) is set will be described.

In the first determination error distribution (not illustrated), a range from the determination error (μA−3σ_{A}) to the determination error (μA+3σ_{A}), inclusive, centered on the average value μA4 of the determination errors is determination error range MSEA4. Furthermore, similarly, in the second determination error distribution (not illustrated), a range from the determination error (μB−3σ_{B}) to the determination error (μB+3σ_{B}), inclusive, centered on the average value μB4 of the determination errors is determination error range MSEB4. In such a case, standard deviation σ_{A} of the first determination error distribution determined to be the non-defective product and standard deviation σ_{B} of the second determination error distribution determined to be the defective product become smaller, but the distance between the average value μA4 and the average value μB4 becomes small, so that the difference between determination error range MSEA4 of the first determination error distribution and determination error range MSEB4 of the second determination error distribution becomes small because.

Therefore, in a case where a bandwidth satisfying driving frequency DF1×2(=360 Hz)<the bandwidth is set, determination performance α3>determination performance α4, but a difference is generated between determination error range MSEA4 and determination error range MSEB4, so that terminal device P1 can determine whether inspection object 1 is a non-defective product or a defective product on the basis of the mean square error.

Correlation graph DPG shows changes in determination performances α1 to α4 of respective cases (i) to (iv) based on the bandwidth. As described above, terminal device P1 cannot perform the non-defective product determination based on the mean square error between the frequency characteristic data that is the input data (approximated data) and the frequency characteristic data that is the output data (predicted data) in a case where determination performance α<0, and can perform the non-defective product determination based on the mean square error in a case where determination performance α≥0. Determination performance α is maximized in a case where a bandwidth satisfying BW1 (=180 Hz)<the bandwidth<driving frequency DF1×2(=360 Hz) is set, and it can be seen that the determination accuracy is most improved in the non-defective product determination (classification determination) based on the mean square error.

As described above, terminal device P1 (an example of the classification device) according to the first exemplary embodiment is a device that determines whether or not inspection object 1 (an example of the object) having the drive source that is periodically driven is a non-defective product, and includes: communication unit 10 (an example of the acquisition unit) that acquires the vibration data (an example of the time-axis waveform data) of inspection object 1 (a motor, an actuator, or the like); frequency characteristic conversion unit 112 (an example of the conversion unit) that converts the vibration data into frequency characteristic data FCG1 (an example of the first frequency characteristic data); section maximum value calculator 114 (an example of the spectrum calculator) that divides frequency characteristic data FCG1 by a predetermined bandwidth (for example, 180 Hz) and calculates the maximum value of the spectrum for each of the division sections; frequency characteristic bandwidth approximation unit 115 (an example of an approximation processing unit) that outputs frequency characteristic data AG1 (input data, approximated data) (an example of the second frequency characteristic data) obtained by approximating frequency characteristic data FCG1 on the basis of the maximum value of the spectrum for each of the division sections; machine learning model generator 117 (an example of the learning model generator) that generates frequency characteristic data FG1 (output data, predicted data) (an example of the third frequency characteristic data) from frequency characteristic data AG1 (input data, approximated data) by using a learning model; and data analyzer 118 (an example of the classification unit) that classifies inspection object 1 on the basis of frequency characteristic data AG1 and frequency characteristic data FG1. The learning model is obtained by learning at least learning data approximated by frequency characteristic bandwidth approximation unit 115.

As a result, terminal device P1 according to the first exemplary embodiment can further improve the determination accuracy of the non-defective product determination regardless of the individual difference of the frequency characteristic data acquired from inspection object 1.

Furthermore, terminal device P1 according to the first exemplary embodiment further includes driving frequency calculator 113 that calculates driving frequency DF1 of the drive source on the basis of frequency characteristic data FCG1. As a result, terminal device P1 according to the first exemplary embodiment can calculate driving frequency DF1 used for setting bandwidth BW1.

Furthermore, terminal device P1 according to the first exemplary embodiment further includes memory 12 (an example of a storage) that stores driving frequency DF1 of the drive source. As a result, terminal device P1 according to the first exemplary embodiment can automatically set bandwidth BW1 by using the driving frequency of the drive source of inspection object 1 recorded in memory 12.

Furthermore, predetermined bandwidth BW1 in terminal device P1 according to the first exemplary embodiment is larger than driving frequency DF1. As a result, since terminal device P1 according to the first exemplary embodiment includes at least one peak Pk1 to Pk6 due to the high frequency component in each of the division sections, each of the division sections of frequency characteristic data FCG1 can be approximated by the maximum value of the spectrum of a respective one of the division sections by frequency characteristic bandwidth approximation unit 115.

Furthermore, predetermined bandwidth BW1 in terminal device P1 according to the first exemplary embodiment is smaller than twice the driving frequency. As a result, terminal device P1 according to the first exemplary embodiment can suppress an increase in the number of peaks caused by the high frequency component in each of the division sections, so that averaging of the spectra in each of the division sections can be suppressed in the approximation processing by frequency characteristic bandwidth approximation unit 115.

Furthermore, frequency characteristic conversion unit 112 in terminal device P1 according to the first exemplary embodiment determines the sampling frequency and the number of sampling points in the conversion of the vibration data. Predetermined bandwidth BW1 is determined on the basis of the sampling frequency=the number of sampling points×N. Here, N is an integer of 1 or more. As a result, terminal device P1 according to the first exemplary embodiment can set bandwidth BW1 that is a frequency band for one or more cycles of the drive source that is periodically driven. Here, one peak occurs for one cycle of the driving operation. Therefore, in a case where bandwidth BW1 is set in the frequency band corresponding to one or more cycles of the drive source, terminal device P1 can further reduce the deviation between the peak generation cycle (that is, the drive cycle of the drive source) and bandwidth BW1 by which frequency characteristic data FCG1 is divided in the approximation processing.

Furthermore, section maximum value calculator 114 in terminal device P1 according to the first exemplary embodiment extracts a predetermined frequency region from frequency characteristic data FCG1, and divides the extracted predetermined frequency region of frequency characteristic data FCG1 by a predetermined bandwidth BW1. As a result, since terminal device P1 according to the first exemplary embodiment can omit the approximation processing of the unnecessary frequency region, the possessing load required for the approximation processing can be reduced, and the processing time required for the approximation processing can be shortened.

Furthermore, data analyzer 118 in terminal device P1 according to the first exemplary embodiment classifies inspection object 1 on the basis of a mean square error between frequency characteristic data AG1 and frequency characteristic data FG1. As a result, since terminal device P1 according to the first exemplary embodiment can limit the calculation target of the mean square error in the non-defective product determination based on the mean square error between frequency characteristic data AG1 (input data) and frequency characteristic data FG1 (output data), the processing load in the non-defective product determination can be reduced and the processing time required for the non-defective product determination can be shortened.

As described above, terminal device P1 (an example of the learning-model generation device) according to the first exemplary embodiment is a device that performs learning with respect to inspection object 1 (object) having the drive source (a motor, an actuator, or the like) that is periodically driven, and includes: communication unit 10 (an example of the acquisition unit) that acquires the time-axis waveform data (an example of the time-axis waveform data) of inspection object 1; frequency characteristic conversion unit 112 (an example of the conversion unit) that converts the time-axis waveform data into frequency characteristic data FCG1 (an example of the first frequency characteristic data); section maximum value calculator 114 (an example of the spectrum calculator) that divides frequency characteristic data FCG1 by a predetermined bandwidth (for example, 180 Hz) and calculates the maximum value of the spectrum for each of the division sections; frequency characteristic bandwidth approximation unit 115 (an example of the approximation processing unit) that outputs frequency characteristic data AG1 (input data, approximated data) (an example of the second frequency characteristic data) obtained by approximating frequency characteristic data FCG1 on the basis of the maximum value of the spectrum for each of the division sections; and machine learning model generator 117 (an example of the learning model generator) that causes the learning model to learn a plurality of pieces of frequency characteristic data AG1.

As a result, terminal device P1 according to the first exemplary embodiment can generate a learning model capable of classifying inspection object 1 regardless of the individual difference of the frequency characteristic data acquired from inspection object 1.

While various exemplary embodiments have been described above with reference to drawings, it is obvious that the present disclosure is not limited thereto. It is obvious that those skilled in the art can conceive various changes, modifications, substitutions, additions, deletions, and equivalents within the scope described in the claims, and it is understood that these naturally belong to the technical scope of the present disclosure. In addition, the respective constituent elements in the above-described various exemplary embodiments may be arbitrarily combined without departing from the gist of the invention.

### Industrial Applicability

The present disclosure is useful as a classification device, a learning-model generation device, a classification method, and a learning-model generation method capable of executing non-defective product determination of an inspection object regardless of an individual difference of the inspection object.

### REFERENCE MARKS IN THE DRAWINGS

1: inspection object
2: vibration sensor
3: analog filter
4: A/D converter
10: communication unit
11: processor
12: memory
13: display unit
111: vibration waveform measurement unit
112: frequency characteristic conversion unit
113: driving frequency calculator
114: section maximum value calculator
115: frequency characteristic bandwidth approximation unit
116: waveform prediction unit
117: machine learning model generator
118: Data analyzer
AG1, FCG1, FCG11, FCG12, FCG21, FCG22, FG1, FG2: frequency characteristic data
SC1, SC2, SC3, SC4, SC5, SC6: division section

1. A classification device that classifies an object having a drive source, the drive source periodically being driven, the classification device comprising:
an acquisition unit that acquires time-axis waveform data of the object;
a conversion unit that converts the time-axis waveform data into first frequency characteristic data;
a spectrum calculator that divides the first frequency characteristic data into division sections by a predetermined bandwidth and calculates a maximum value of a spectrum for each of the division sections;
an approximation processing unit that outputs second frequency characteristic data obtained by approximating the first frequency characteristic data on a basis of the maximum value of the spectrum for each of the division sections;
a generator that generates third frequency characteristic data from the second frequency characteristic data by using a learning model; and
a classification unit that classifies the object on a basis of the second frequency characteristic data and the third frequency characteristic data,
wherein the learning model is a model that has learned at least learning data approximated by the approximation processing unit.

2. The classification device according to claim 1, further comprising a driving frequency calculator that calculates a driving frequency of the drive source on a basis of the first frequency characteristic data.

3. The classification device according to claim 1, further comprising a storage that stores the driving frequency of the drive source.

4. The classification device according to claim 2,
wherein the predetermined bandwidth is larger than the driving frequency.

5. The classification device according to claim 2,
wherein the predetermined bandwidth is smaller than twice the driving frequency.

6. The classification device according to claim 1,
wherein the conversion unit determines a sampling frequency and the number of sampling points in the conversion of the time-axis waveform data, and
the predetermined bandwidth is determined on a basis of the sampling frequency÷the number of sampling points×N, where N is an integer greater than or equal to 1.

7. The classification device according to claim 1,
wherein the spectrum calculator extracts a predetermined frequency region from the first frequency characteristic data and divides the extracted predetermined frequency region by the predetermined bandwidth.

8. The classification device according to claim 1,
wherein the classification unit classifies the object on a basis of a mean square error between the second frequency characteristic data and the third frequency characteristic data.

9. A learning-model generation device that performs learning on an object having a drive source, the drive source periodically being driven, the learning-model generation device comprising:
an acquisition unit that acquires time-axis waveform data of the object;
a conversion unit that converts the time-axis waveform data into first frequency characteristic data;
a spectrum calculator that divides the first frequency characteristic data into division sections by a predetermined bandwidth and calculates a maximum value of a spectrum for each of the division sections;
an approximation processing unit that outputs second frequency characteristic data obtained by approximating the first frequency characteristic data on a basis of the maximum value of the spectrum for each of the division sections; and
a learning model generator that causes a learning model to learn a plurality of the second frequency characteristic data.

10. A classification method performed by a classification device that classifies an object having a drive source, the drive source periodically being driven, the classification method comprising:
acquiring time-axis waveform data of the object;
converting the time-axis waveform data into first frequency characteristic data;
dividing the first frequency characteristic data into division sections by a predetermined bandwidth and calculates a maximum value of a spectrum for each of the division sections;
outputting second frequency characteristic data obtained by approximating the first frequency characteristic data on a basis of the maximum value of the spectrum for each of the division sections;
generating third frequency characteristic data from the second frequency characteristic data by using a learning model; and
classifying the object on a basis of the second frequency characteristic data and the third frequency characteristic data,
wherein the learning model is a model that has learned at least learning data approximated by the classification device.

11. The classification method according to claim 10, further comprising calculating a driving frequency of the drive source on a basis of the first frequency characteristic data.

12. The classification method according to claim 10, further comprising storing a driving frequency of the drive source.

13. The classification method according to claim 11,
wherein the predetermined bandwidth is larger than the driving frequency.

14. The classification method according to claim 11,
wherein the predetermined bandwidth is smaller than twice the driving frequency.

15. The classification method according to claim 10,
wherein the converting determines a sampling frequency and the number of sampling points in the conversion of the time-axis waveform data, and
the predetermined bandwidth is determined on a basis of the sampling frequency:
the number of sampling points×N, where N is an integer greater than or equal to 1.

16. The classification method according to claim 10,
wherein the dividing extracts a predetermined frequency region from the first frequency characteristic data and divides the extracted predetermined frequency region by the predetermined bandwidth.

17. The classification method according to claim 10,
wherein the classifying classifies the object on a basis of a mean square error between the second frequency characteristic data and the third frequency characteristic data.

18. A learning-model generation method performed by a learning-model generation device that performs learning on an object having a drive source, the drive source periodically being driven, the learning-model generation method comprising:
acquiring time-axis waveform data of the object;
converting the time-axis waveform data into first frequency characteristic data;
dividing the first frequency characteristic data into division sections by a predetermined bandwidth and calculating a maximum value of a spectrum for each of the division sections;
outputting second frequency characteristic data obtained by approximating the first frequency characteristic data on a basis of the maximum value of the spectrum for each of the division sections; and
causing a learning model to learn a plurality of the second frequency characteristic data.
